(19) United States
(12) Patent Application Publication
(10) Pub. No.: US 2017/0315996 A1
(43) Pub. Date: Nov. 2, 2017

(54) FOCUSED SENTIMENT CLASSIFICATION

(71) Applicant: LONGSAND LIMITED, Cambridge (GB)

(72) Inventor: John Simon Fothergill, Cambridge (GB)

(21) Appl. No.: 15/523,623

(22) PCT Filed: Oct. 31, 2014
(86) PCT No.: PCT/EP2014/073495

§ 371 Date: May 1, 2017

(51) Int. Cl. G06F 17/30; G06N 5/02

(52) U.S. Cl. CPC G06F 17/30011; G06N 5/02; G06F 17/30516; G06F 17/30598; G06F 17/30864

(57) ABSTRACT

A computing device includes at least one processor and a sentiment analysis module. The sentiment analysis module is to, for each document set of a plurality of document sets, determine a distribution of sentiment classes for documents included in the document set. The sentiment analysis module is also to select, from the plurality of document sets, a first document set for analyzing a target document, and set a prior distribution of sentiment classes of the target document equal to the distribution of sentiment classes for documents included in the first document set. The sentiment analysis module is also to perform a Bayesian classification of the target document using a training data set and the prior distribution of sentiment classes of the target document, and determine a sentiment class for the target document based on the Bayesian classification.

### BACKGROUND

Some computing systems can use documents including written text. Further, some computing systems may attempt to interpret the meaning of such documents. For example, a spam filter can receive incoming emails, and may attempt to determine a meaning of the text content of the email. The spam filter may then identify undesirable emails based on the meaning of text content.

### BRIEF DESCRIPTION OF THE DRAWINGS

Some implementations are described with respect to the following figures.

FIG. 1 is a schematic diagram of an example computing device, in accordance with some implementations.

FIG. 2 is an illustration of an example sentiment analysis operation according to some implementations.

FIG. 3 is an illustration of an example data flow according to some implementations.

FIG. 4 is a flow diagram of a process for sentiment classification in accordance with some implementations.

FIG. 5 is a flow diagram of a process for sentiment classification in accordance with some implementations.

### DETAILED DESCRIPTION

In some computing systems, the sentiment of a document may be estimated based on the words included in the document. However, some words may indicate different sentiments depending on the context of the document, and may therefore cause an erroneous estimate of the sentiment. For example, in a document related to a medicine topic, the word “sick” can indicate a negative sentiment. However, in document related to a popular music topic, the word “sick” may be used as a slang term indicating a positive sentiment. In another example, a particular word may generally be used to indicate a positive sentiment, but may be used sarcastically in a specific context, and may thus indicate a negative sentiment in that context.

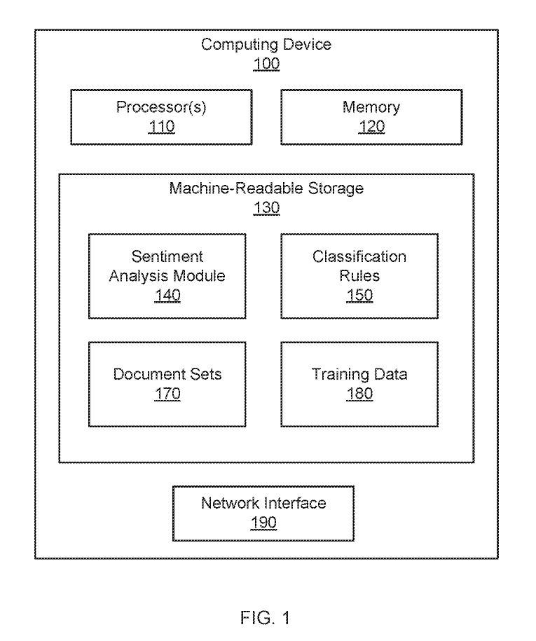

In accordance with some implementations, techniques or mechanisms are provided for sentiment classification of a target document. As described further below with reference to FIGS. 1-5, some implementations may include groups of documents corresponding to particular contexts. A sentiment profile may be generated for each group using a set of written rules. Upon receiving a target document, a particular group may be selected based on relevancy to the target document. A machine learning classification of the target document may be performed using a training data set and the sentiment profile of the selected group. In some implementations, a context-focused sentiment classification of the target document may be provided.

FIG. 1 is a schematic diagram of an example computing device 100, in accordance with some implementations. The computing device 100 may be, for example, a computer, a portable device, a server, a network device, a communication device, etc. Further, the computing device 100 may be any grouping of related or interconnected devices, such as a blade server, a computing cluster, and the like. Furthermore, in some implementations, the computing device 100 may be a dedicated device for estimating the sentiment of text information.

As shown, the computing device 100 can include processor(s) 110, memory 120, machine-readable storage 130, and a network interface 130. The processor(s) 110 can include a microprocessor, microcontroller, processor module or subsystem, programmable integrated circuit, programmable gate array, multiple processors, a microprocessor including multiple processing cores, or another control or computing device. The memory 120 can be any type of computer memory (e.g., dynamic random access memory (DRAM), static random-access memory (SRAM), etc.).

The network interface 190 can provide inbound and outbound network communication. The network interface 190 can use any network standard or protocol (e.g., Ethernet, Fibre Channel, Fibre Channel over Ethernet (FCoE), Internet Small Computer System Interface (iSCSI), a wireless network standard or protocol, etc.). Further, network interface 190 can provide communication with information sources such as internet websites, RSS (Rich Site Summary) feeds, social media applications, news sources, messaging platforms, and so forth.

In some implementations, the machine-readable storage 130 can include non-transitory storage media such as hard drives, flash storage, optical disks, etc. As shown, the machine-readable storage 130 can include a sentiment analysis module 140, classification rules 150, document sets 170, and training data 180.

In some implementations, the sentiment analysis module 140 can receive one or more feeds of documents via the network interface 190. For example, the sentiment analysis module 140 can receive a continuous feed from sources such as RSS feeds, social media postings, news wires, text messages, subscription feeds, etc. The documents feeds may be scheduled or unscheduled, and may be provided over an unlimited or extended period of time (e.g., every minute, every day, at random intervals, at various times during one or more years, etc.). In some implementations, the sentiment analysis module 140 can route the received documents to one or more document sets 170.

In some implementations, each document set 170 can be a group of documents associated with a particular context. For example, specific document sets 170 may be dedicated to topics such as politics, business news, football, baseball, music, gaming, hobbies, health, finance, movies, a television series, and the like. As used herein, the term “document” can refer to any data structure including language information. For example, documents can include text information (e.g., a word-processing document, a comment, an email, a social media posting, a text message, an article, a book, a database entry, a blog post, a review, a tag, an image, and so forth). In another example, documents can include speech information (e.g., an audio recording, a video recoding, a voice message, etc.).

In some implementations, the classification rules 150 can be a stored set of hand-crafted rules, which may be written by human analysts. Further, the classification rules 150 can be rewritten and updated by human analysts as need to reflect current changes in a context or topic.

The classification rules 150 can identify predefined sequences of characters or words in a document, and can associate those sequences with different classes of sentiment. Further, the classification rules 150 may specify different classes of sentiment depending on the context or topic of the document set 170 being analyzed. In some implementations, the sentiment analysis module 140 can use the classification rules 150 to determine a sentiment classification for each document in the document sets 170.

The sentiment analysis module 140 can use the sentiment classifications to generate a sentiment distribution for each document set 170. For example, the sentiment distribution of a document set 170 may indicate the proportions or quantities of documents that are classified in various sentiment classes. A sentiment class may correspond to a type or amount of favorability (e.g., very positive, slightly positive, neutral, slightly negative, very negative, etc.).

In some implementations, the sentiment analysis module 140 can receive a target document for sentiment analysis. The sentiment analysis module 140 can select a particular document set 170 for analyzing the target document. The selection of a particular document set 170 can be on a measure of relevancy of each document set 170 to the target document. In some implementations, the measure of relevancy of each document set 170 can be obtained by performing a query for key terms of the target document that are included the document sets 170. For example, a query may return the number of documents in each document set 170 that include key terms in common with the target document. In this example, the sentiment analysis module 140 may then select the document set 170 with the highest number of documents with common terms to analyze the target document.

In some implementations, the sentiment analysis module 140 can set a prior sentiment profile of the target document equal to the sentiment profile associated with the document set 170 selected for analyzing the target document. The sentiment analysis module 140 can perform a machine learning classification of the target document. The machine learning classification can be a statistical learning algorithm which is trained using the training data 180. Further, the machine learning classification of the target document can be a statistical learning algorithm which uses the prior sentiment profile of the target document as an input to specify the prior probabilities of each class (i.e., the assumed likelihood of membership in that class). In some implementations, the machine learning classification can be a Bayesian classification of the target document (e.g., a naive Bayes classifier). For example, the sentiment analysis module 140 may perform a supervised learning classification of the target document using a Bayes classifier that is trained using the training data 180, and that uses the prior sentiment profile of the target document to determine the prior probabilities for each class. In some implementations, the machine learning classification can provide a posterior probability that the target document is a member of any given class. Further, the sentiment analysis module 140 can determine a sentiment class for the target document based on the results of the machine learning classification.

The training data 180 may be a set of examples for use in machine learning classification. In some implementations, the training data 180 may be a corpus of text information that has been annotated by a human analyst. The training data 180 may include linguistic annotations (e.g., tags, metadata, comments, etc.). In some implementations, the training data 180 can be generalized (i.e., not specific to a particular topic or context). Further, the training data 180 may be substantially static, and may not be updated continually and/or automatically. In comparison, the document sets 170 may be updated relatively frequently by documents received from feeds. Further, the classification rules 150 can be rewritten and updated relatively frequently by human users to reflect any current changes in a context or topic.

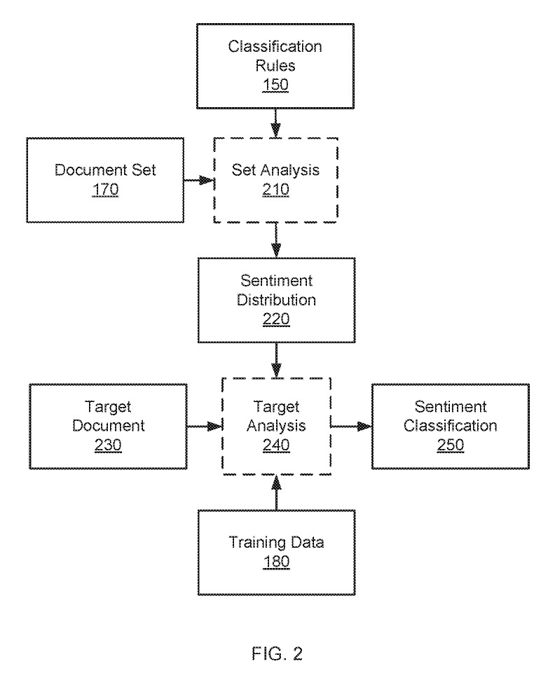

Various aspects of the sentiment analysis module 140, the classification rules 150, the document sets 170, and the training data 180 are discussed further below with reference to FIGS. 2-5. Note that any of these aspects can be implemented in any suitable manner. For example, the sentiment analysis module 140 can be hard-coded as circuitry included in the processor(s) 110 and/or the computing device 100. In other examples, the sentiment analysis module 140 can be implemented as machine-readable instructions included in the machine-readable storage 130.

Referring now to FIG. 2, shown is an illustration of an example sentiment analysis operation according to some implementations. As shown, the classification rules 150 may be used to perform a set analysis 210 of a particular document set 170. For example, the classification rules 150 may identify words or phrases that indicate particular sentiments when used within a context of the document set 170. The set analysis 210 may generate a sentiment distribution 220 associated with the document set 170.

The sentiment distribution 220 may be used to perform a target analysis 240 of a target document 230. For example, assume that the target analysis 240 involves a Bayesian classification of the target document 230. Accordingly, the prior sentiment distribution of the target document 230 may be set equal to the sentiment distribution 220, and may used as an input for the Bayesian classification of the target document 230. Further, the training data 180 may also be used as an input for the Bayesian classification of the target document 230. As shown, the target analysis 240 provides a sentiment classification 250 for the target document 230.

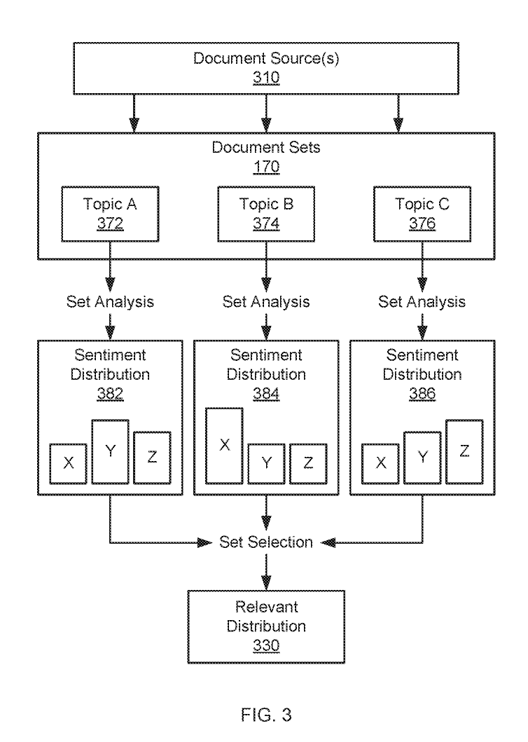

Referring now to FIG. 3, shown is an illustration of an example data flow according to some implementations. As shown, the document source(s) 310 may provide a continuous feed of documents to be included in the document sets 170. In some implementations, each document set 170 may correspond to a particular topic. By way of example, FIG. 3 illustrates the document sets 170 as including a “Topic A” document set 372, a “Topic B” document set 374, and a “Topic C” document set 376.

As shown, a set analysis of the “Topic A” document set 372 can provide a sentiment distribution 382. In some implementations, the set analysis of the “Topic A” document set 372 may be performed using written rules associated with “Topic A” (e.g., a sub-set of the classification rules 150 shown in FIGS. 1-2). Similarly, a set analysis of the “Topic B” document set 374 can provide a sentiment distribution 384, and a set analysis of the “Topic C” document set 376 can provide a sentiment distribution 386.

In some implementations, the sentiment distributions 382, 384, and 386 may include information as to the number of documents that are classified in various sentiment classes. For the sake of illustration, FIG. 3 shows the sentiment distributions 382, 384, 386 as including various sizes of sentiment classes X, Y, and Z, representing the quantities of documents of document sets 372, 374, 376 that are included in the corresponding sentiment class.

In some implementations, subsequent to obtaining the sentiment distributions 382, 384, and 386, a target document may be received for sentiment classification. In response to receiving the target document, a set selection may determine a particular document set (e.g., one of the document sets 372, 374, 376) that is most relevant to the target document. Further, the sentiment profile (e.g., one of the sentiment distributions 382, 384, 386) corresponding to the most relevant document set may be determined to be the relevant distribution 330. In some implementations, the relevant distribution 330 can be set as the prior sentiment distribution of the target document, and can then used as an input for a Bayesian classification of the target document.

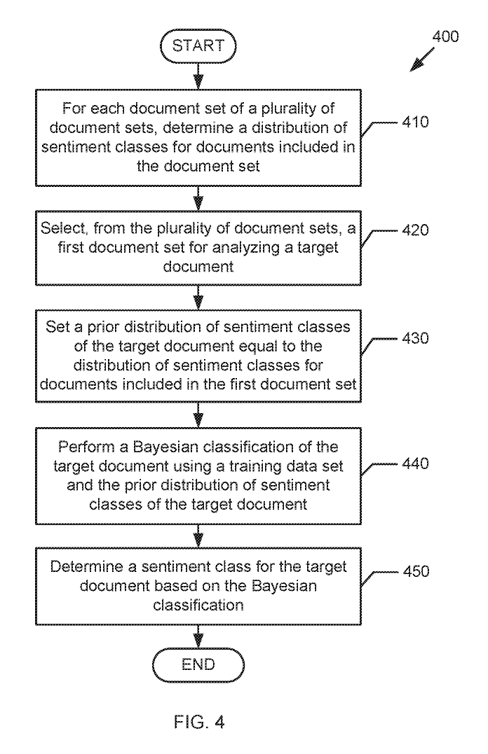

Referring now to FIG. 4, shown is a process 400 for sentiment classification in accordance with some implementations. The process 400 may be performed by the processor(s) 110 and/or the sentiment analysis module 140 shown in FIG. 1. The process 400 may be implemented in hardware or machine-readable instructions (e.g., software and/or firmware). The machine-readable instructions are stored in a non-transitory computer readable medium, such as an optical, semiconductor, or magnetic storage device. For the sake of illustration, details of the process 400 may be described below with reference to FIGS. 1-3, which show examples in accordance with some implementations. However, other implementations are also possible.

At 410, for each document set of a plurality of document sets, a distribution of sentiment classes for documents included in the document set may be determined. In some implementations, the distribution of sentiment classes may be determined using a stored set of written rules. For example, referring to FIG. 1, the sentiment analysis module 140 may use the classification rules 150 to determine a sentiment classification for each document in the document sets 170. In some implementations, the classification rules 150 can be rewritten and updated by human users to reflect changes in a context or topic.

At 420, a first document set may be selected for use in analyzing a target document. In some implementations, the first document set may be selected using a query for key terms of the target document. For example, referring to FIG. 1, the sentiment analysis module 140 may determine the number of documents in each document set 170 that include common terms with the target document, and may select the document set 170 with the highest number of documents including common terms with the target document.

At 430, a prior distribution of sentiment classes of the target document may be set equal to the distribution of sentiment classes for documents included in the first document set. For example, referring to FIG. 2, the prior distribution of sentiment classes of the target document 230 can be set equal to the sentiment distribution 220.

At 440, a Bayesian classification of the target document may be performed using a training data set and the prior distribution of sentiment classes of the target document. In some implementations, the training data set may be a static corpus of annotated information. For example, referring to FIG. 1-2, the sentiment analysis module 140 may perform a Bayesian classification of the target document 230 using the training data 180 and the sentiment distribution 220.

At 450, a sentiment class for the target document may be determined based on the Bayesian classification. For example, referring to FIG. 1-2, the sentiment analysis module 140 may determine the sentiment classification 250 based on the Bayesian classification of the target document 230. After 450, the process 400 is completed.

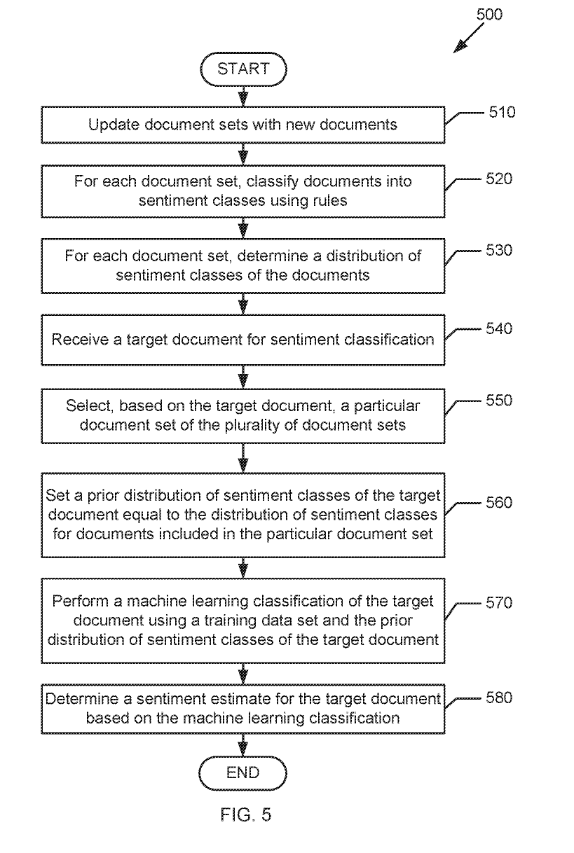

Referring now to FIG. 5, shown is a process 500 for sentiment classification in accordance with some implementations. The process 500 may be performed by the processor(s) 110 and/or the sentiment analysis module 140 shown in FIG. 1. The process 500 may be implemented in hardware or machine-readable instructions (e.g., software and/or firmware). The machine-readable instructions are stored in a non-transitory computer readable medium, such as an optical, semiconductor, or magnetic storage device. For the sake of illustration, details of the process 400 may be described below with reference to FIGS. 1-3, which show examples in accordance with some implementations. However, other implementations are also possible.

At 510, a plurality of document sets may be updated with new documents. In some implementations, the new documents may be received from continuous feeds. For example, referring to FIGS. 1 and 3, the sentiment analysis module 140 may continuously update the document sets 170 from the document sources 310. In some implementations, the sentiment analysis module 140 may determine a topic associated with a document source 310 and/or a new document, and may include information from the new document in a document set 170 associated with the determined topic. In some embodiments, the new documents may be received via the network interface 190.

At 520, the documents included in each document set may be classified into sentiment classes using a set of rules. For example, referring to FIG. 1, the sentiment analysis module 140 may use the classification rules 150 to determine a sentiment classification for each document in the document sets 170. In some implementations, the classification rules 150 may be hand-crafted by human users based on an understanding of specific topics.

At 530, for each document set, a distribution of sentiment classes for documents in the document set may be determined. For example, referring to FIGS. 1-3, the sentiment analysis module 140 may determine the sentiment distributions 382, 384, 386 based on the sentiment classification for each document in the document sets 372, 374, 376.

At 540, a target document may be received for sentiment classification. For example, referring to FIGS. 1-2, the sentiment analysis module 140 may receive the target document 230 for sentiment classification. In some embodiments, the target document 230 may be received via the network interface 190.

At 550, a particular document set may be selected based on the target document. In some implementations, the particular document set may be selected based on a measure of relevancy to the target document. For example, referring to FIG. 1, the sentiment analysis module 140 may determine the relevancy of each document set 170 to the target document, and may select the most relevant document set 170. In some implementations, the relevancy may be computed based on common terms between the target document and the document sets 170. For example, the relevancy may be determined using a Okapi BM25 model, a Bayesian query language model, and so forth.

At 560, a prior distribution of sentiment classes of the target document may be set equal to the distribution of sentiment classes for documents included in the particular document set. For example, referring to FIG. 2, the prior distribution of sentiment classes of the target document 230 can be set equal to the sentiment distribution 220.

At 570, a machine learning classification of the target document may be performed using a training data set and the prior distribution of sentiment classes of the target document. In some implementations, the machine learning classification of the target document may involve a naive Bayesian classifier. For example, referring to FIG. 1-2, the sentiment analysis module 140 may perform a naive Bayesian classification of the target document 230 using inputs of the training data 180 and the prior distribution of sentiment classes of the target document 230.

At 580, a sentiment class for the target document may be determined based on the machine learning classification. For example, referring to FIG. 1-2, the sentiment analysis module 140 may determine the sentiment classification 250 based on the machine learning classification of the target document 230. After 580, the process 500 is completed.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A computing device comprising:
at least one processor;
a sentiment analysis module executable on the at least one processor to:
for each document set of a plurality of document sets, determine a distribution of sentiment classes for documents included in the document set;
select, from the plurality of document sets, a first document set for analyzing a target document;
set a prior distribution of sentiment classes of the target document equal to the distribution of sentiment classes for documents included in the first document set;
perform a Bayesian classification of the target document using a training data set and the prior distribution of sentiment classes of the target document; and
determine a sentiment class for the target document based on the Bayesian classification.

2. The computing device of claim 1, the sentiment analysis module further to:
receive a feed of new documents;
update at least one document set of the plurality of document sets to include the new documents; and
for the at least one document set of the plurality of document sets, update the distribution of sentiment variables in response to receiving the new documents.

3. The computing device of claim 2, wherein the feed of new documents comprises a continuous feed from a social media platform.

4. The computing device of claim 1, wherein the sentiment analysis module is to determine the distribution of sentiment classes for the documents included in the document set using a set of written rules.

5. The computing device of claim 1, wherein each document set of the plurality of document sets is associated with a particular topic.

6. The computing device of claim 1, wherein the sentiment analysis module is to select the first document set based on a query for common terms between the target document and the plurality of document sets.

7. The computing device of claim 1, wherein the training data set is substantially static and includes at least one annotation.

8. A method comprising:
receiving a target document for sentiment classification;
selecting, based on the target document, a particular document set of a plurality of document sets;
obtaining a distribution of sentiment classes associated with the particular document set;
setting a prior distribution of sentiment classes of the target document equal to the distribution of sentiment classes for documents included in the particular document set;
performing a machine learning classification of the target document using a training data set and the prior distribution of sentiment variables of the target document; and
determining a sentiment class for the target document based on the machine learning classification.

9. The method of claim 8, wherein performing a machine learning classification comprises performing a Bayesian classification.

10. The method of claim 8, wherein selecting the particular document set comprises determining a relevancy of each of the plurality of document sets based on key terms included in the target document.

11. The method of claim 8, further comprising:
updating the plurality of document sets based on a continuous feed of new documents; and
for each document set of the plurality of document sets, updating the distribution of sentiment variables based on the new documents.

12. The method of claim 8, further comprising:
determining the distribution of sentiment classes associated with the particular document set using a stored set of written rules.

13. An article comprising at least one non-transitory machine-readable storage medium storing instructions that upon execution cause at least one processor to:
obtain a plurality of document sets, wherein each document set of the plurality of document sets comprises a plurality of documents;
for each document set of the plurality of document sets, determine a distribution of sentiment classes for the plurality of documents included in the document set using a stored set of written rules;
select, from the plurality of document sets, a first document set based on a measure of relevancy to a target document;
set a prior distribution of sentiment classes of the target document equal to the distribution of sentiment classes for documents included in the first document set;
perform a Bayesian classification of the target document using a static training data set and the prior distribution of sentiment classes of the target document; and
determine a sentiment class for the target document based on the Bayesian classification.

14. The article of claim 13, wherein the instructions further cause the processor to:
receive a feed of new documents to be included in the plurality of document sets;
in response to receiving the feed of new documents, update the distribution of sentiment variables of at least one document set of the plurality of document sets.

15. The article of claim 14, wherein the instructions further cause the processor to:
determine the measure of relevancy to the target document using a query for key terms included in the target document.
